(19) United States
(12) Patent Application Publication
(10) Pub. No.: US 2008/0106545 A1
(43) Pub. Date: May 8, 2008

(54) SIMULATING CULTURAL COMMUNICATIONS

(76) Inventors: Gene Fein, Lenox, MA (US); Edward Merritt, Lenox, MA (US)

Correspondence Address: BERKELEY LAW & TECHNOLOGY GROUP, LLP, 17933 NW Evergreen Parkway, Suite 250, BEAVERTON, OR, 97006, US

(21) Appl. No.: 11/556,090

(22) Filed: Nov. 2, 2006

(51) Int. Cl. G06F 17/00

(52) U.S. Cl. 345/418

(57) ABSTRACT

Briefly, in accordance with one or more embodiments, one or more portable electronic devices may be used to simulate cultural communications.

### BACKGROUND

Certain cultural morays for communication occasionally may be displayed via common means based upon a cultural norm. Currently, the means for these communications is largely three dimensional utilizing real objects to signify the message that one seeks to communicate. Conventional models for such cultural communication include the use of mistletoe during the holiday season strategically placed overhead to obtain a kiss, the use of a lighter at concerts to engender audience participation as a community with the performance, and the giving of various hand signals from the Hawaiian ‘hang-loose’ signal to the ‘peace’ sign, among many other culturally acknowledged symbols of this kind.

### DESCRIPTION OF THE DRAWING FIGURES

Claimed subject matter is particularly pointed out and distinctly claimed in the concluding portion of the specification. However, both as to organization and/or method of operation, together with objects, features, and/or advantages thereof, it may best be understood by reference to the following detailed description when read with the accompanying drawings in which:

FIG. 1 is a flow diagram of a procedure for operating a portable electronic device in accordance with one or more embodiments;

FIG. 2 is an illustration of a portable electronic device in accordance with one or more embodiments;

FIG. 3 is an illustration of a portable electronic device in accordance with one or more embodiments;

FIG. 4 is an illustration of a portable electronic device in accordance with one or more embodiments;

FIG. 5 is an illustration of a portable electronic device in accordance with one or more embodiments;

FIG. 6 is an illustration of a portable electronic device in use in accordance with one or more embodiments;

FIG. 7 is an illustration of a portable electronic device in accordance with one or more embodiments;

FIG. 8 is an illustration of a portable electronic device in use in accordance with one or more embodiments;

FIG. 9 is an illustration of a portable electronic device in accordance with one or more embodiments;

FIG. 10 is an illustration of a portable electronic device in use in accordance with one or more embodiments;

FIG. 11 is an illustration of a portable electronic device in accordance with one or more embodiments;

FIG. 12 is an illustration of a portable electronic device in accordance with one or more embodiments; and

FIG. 13 is a block diagram of a computing platform in accordance with one or more embodiments.

Reference is made in the following detailed description to the accompanying drawings, which form a part hereof, wherein like numerals may designate like parts throughout to indicate corresponding or analogous elements. It will be appreciated that for simplicity and/or clarity of illustration, elements illustrated in the figures have not necessarily been drawn to scale. For example, the dimensions of some of the elements may be exaggerated relative to other elements for clarity. Further, it is to be understood that other embodiments may be utilized and structural and/or logical changes may be made without departing from the scope of the claimed subject matter. It should also be noted that directions and references, for example, up, down, top, bottom, and so on, may be used to facilitate the discussion of the drawings and are not intended to restrict the application of the claimed subject matter. Therefore, the following detailed description is not to be taken in a limiting sense and the scope of the claimed subject matter defined by the appended claims and their equivalents.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail.

Some portions of the detailed description that follow are presented in terms of algorithms, programs and/or symbolic representations of operations on data bits or binary digital signals within a computer memory, for example. These algorithmic descriptions and/or representations may include techniques used in the data processing arts to transfer the arrangement of a computing platform, such as a computer, a computing system, an electronic computing device, and/or other information handling system, to operate according to such programs, algorithms, and/or symbolic representations of operations. A program and/or process generally may be considered to be a self-consistent sequence of acts and/or operations leading to a desired result. These include physical manipulations of physical quantities. Usually, though not necessarily, these quantities take the form of electrical and/or magnetic signals capable of being stored, transferred, combined, compared, and/or otherwise manipulated. It has proven convenient at times, principally for reasons of common usage, to refer to these signals as bits, values, elements, symbols, characters, terms, numbers and/or the like. It should be understood, however, that all of these and/or similar terms are to be associated with the appropriate physical quantities and are merely convenient labels applied to these quantities. In addition, embodiments are not described with reference to any particular programming language. It will be appreciated that a variety of programming languages may be used to implement the teachings described herein.

Embodiments claimed may include one or more apparatuses for performing the operations herein. These apparatuses may be specially constructed for the desired purposes, or it may comprise a general purpose a computing platform, such as a computer, a computing system, an electronic computing device, and/or other information handling system, for example, selectively activated and/or reconfigured by a program stored in the device. The processes and/or displays presented herein are not inherently related to any particular computing platform and/or other apparatus. Various general purpose computing platforms may be used with programs in accordance with the teachings herein, or it may prove convenient to construct a more specialized computing platform to perform the desired method. The desired structure for a variety of these computing platforms will appear from the description below.

Embodiments claimed may include software capable of performing one or more of the operations described herein. Although the claimed subject matter is not limited in scope in this respect, one embodiment may be in hardware, such as implemented to operate on a device or combination of devices, whereas another embodiment may be in software. Likewise, an embodiment may be implemented in firmware, or as any combination of hardware, software, and/or firmware, for example. Likewise, although the claimed subject matter is not limited in scope in this respect, one embodiment may comprise one or more articles, such as a storage medium or storage media. This storage media may have stored thereon instructions that when executed by a computing platform, such as a computer, a computing system, an electronic computing device, and/or other information handling system, for example, may result in an embodiment of a method in accordance with the claimed subject matter being executed, for example.

In the following description and/or claims, the terms “storage medium” and/or “storage media” as referred to herein relate to media capable of maintaining expressions which are perceivable by one or more machines. For example, a storage medium may comprise one or more storage devices for storing machine-readable instructions and/or information. Such storage devices may comprise any one of several media types including, but not limited to, any type of magnetic storage media, optical storage media, semiconductor storage media, disks including floppy disks, optical disks, CD-ROMs, magnetic-optical disks, read-only memories (ROMs), random access memories (RAMs), electrically programmable read-only memories (EPROMs), electrically erasable and/or programmable read-only memories (EEPROMs), flash memory, magnetic and/or optical cards, and/or any other type of media suitable for storing electronic instructions, and/or capable of being coupled to a system bus for a computing platform. However, these are merely examples of a storage medium, and the scope of the claimed subject matter is not limited in this respect.

In the following description and/or claims, the term “instructions” as referred to herein relates to expressions which represent one or more logical operations. For example, instructions may be machine-readable by being interpretable by a machine for executing one or more operations on one or more data objects. However, this is merely an example of instructions, and the scope of claimed subject matter is not limited in this respect. In another example, instructions as referred to herein may relate to encoded commands which are executable by a processor having a command set which includes the encoded commands. Such an instruction may be encoded in the form of a machine language understood by the processor. However, these are merely examples of an instruction, and the scope of the claimed subject matter is not limited in this respect.

Unless specifically stated otherwise, as apparent from the following discussion, it is appreciated that throughout this specification discussions utilizing terms such as processing, computing, calculating, selecting, forming, enabling, inhibiting, identifying, initiating, receiving, transmitting, determining, displaying, sorting, delivering, requesting, downloading, appending, making and/or the like refer to the actions and/or processes that may be performed by a computing platform, such as a computer, a computing system, an electronic computing device, and/or other information handling system, that manipulates and/or transforms data represented as physical electronic and/or magnetic quantities and/or other physical quantities within the computing platform's processors, memories, registers, and/or other information storage, transmission, reception and/or display devices. Further, unless specifically stated otherwise, processes described herein, with reference to flow diagrams or otherwise, may also be executed and/or controlled, in whole or in part, by such a computing platform.

In the following description and/or claims, the term “and/or” as referred to herein may mean “and”, it may mean “or”, it may mean “exclusive-or”, it may mean “one”, it may mean “some, but not all”, it may mean “neither”, and/or it may mean “both”, although the scope of claimed subject matter is not limited in this respect.

In the following description and/or claims, the terms “coupled” and/or “connected”, along with their derivatives, may be used. In particular embodiments, connected may be used to indicate that two or more elements are in direct physical and/or electrical contact with each other. Coupled may mean that two or more elements are in direct physical and/or electrical contact. However, coupled may also mean that two or more elements may not be in direct contact with each other, but yet may still cooperate and/or interact with each other.

In the following description and/or claims, the term “culturally significant object” as referred to herein relates to an object that comprises a well understood cultural meaning and/or connotation and/or ritualistic role to one or more cultural groups and/or segments of population. However, this is merely an example, and the scope of the claimed subject matter is not limited in this respect.

Reference throughout this specification to “one embodiment” or “an embodiment” means that a particular feature, structure, or characteristic described in connection with the embodiment is included in at least one embodiment of the claimed subject matter. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more embodiments.

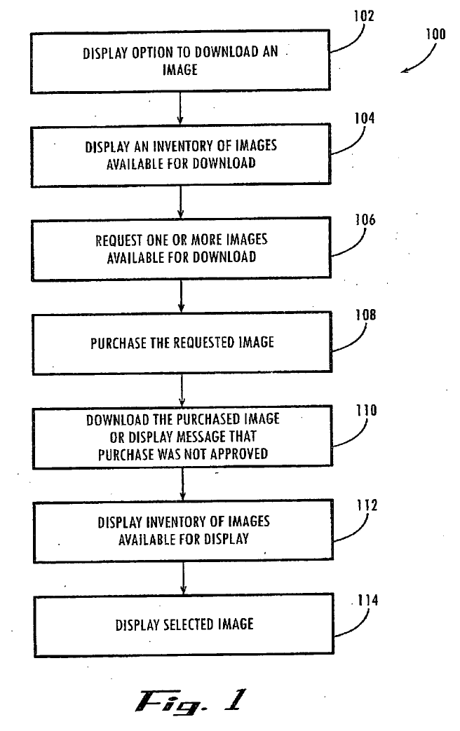

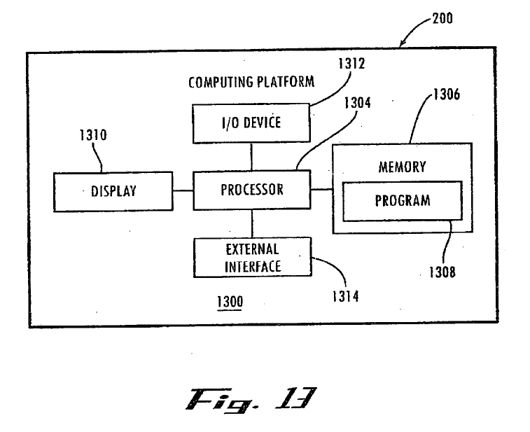

Referring now to FIG. 1, a flow diagram illustrates an example procedure for operating a portable electronic device (not shown) in accordance with one or more embodiments, although the claimed subject matter is not limited in scope in this respect. In the description and/or claims, the term “portable electronic device” as referred to herein relates to handheld computers, Personal Digital Assistants, tablet computers, pocket personal computers (PPC), mobile phones, smartphones, portable media players, or the like, or combinations thereof. However, this is merely an example, and the scope of the claimed subject matter is not limited in this respect. The procedure 100 illustrated in FIG. 1 may be used to operate a portable electronic device to display an image comprising a culturally significant object and/or a hand gesture conveying a message through non-verbal communication, although the claimed subject matter is not limited in this respect. Additionally, although procedure 100, as shown in FIG. 1, comprises one particular order of blocks, the order in which the blocks are presented does not necessarily limit the claimed subject matter to any particular order. Likewise, intervening blocks shown in FIG. 13 and/or additional blocks not shown in FIG. 1 may be employed and/or blocks shown in FIG. 1 may be eliminated, without departing from the scope of the claimed subject matter.

Procedure 100 depicted in FIG. 1 may in alternative embodiments be implemented in software, hardware, and/or firmware, and may comprise discrete operations. As illustrated, procedure 100 starts at block 102 where the portable electronic device may display an option to download an image. Alternatively or additionally, the portable electronic device may be pre-loaded at the factory with an inventory of one or more pre-set images for display. At block 104, the portable electronic device may display an inventory of one or more images available for download once the user has selected the option to download an image. At block 106, the portable electronic device may transmit a request for one or more images available for downloading from a server (not shown). At block 108, the portable electronic device may purchase the requested one or more images by performing one or more communications back and forth with the server to validate billing. Alternatively or additionally, the operation of purchasing may be excluded from the procedure 100. At block 110, the portable electronic device may download the one or more purchased images. Alternatively or additionally, at block 110, the portable electronic device may display a confirmation message that the image has been downloaded, such as by a message that appears in an inbox, although the claimed subject matter is not limited in scope in this respect. Alternatively or additionally, at block 110, the portable electronic device may display a message that the purchase was not approved. At block 112, the portable electronic device may display an inventory of images available for display from which a user may select.

At block 114, the portable electronic device may display selected images. Alternatively or additionally, at block 114, the portable electronic device may play an audio accompaniment in conjunction with the displaying. The image displayed by the portable electronic device may comprise a culturally significant object conveying a message through non-verbal communication. The culturally significant object may comprise mistletoe, a lighter and flame, or a flame, or the like. Alternatively or additionally, the image displayed by the portable electronic device may comprise a hand gesture conveying a message through non-verbal communication. The hand gesture comprises one or more of the following: an I love you gesture, a hang-loose gesture, a peace gesture, an extended middle finger gesture, or the like or combinations thereof. Alternatively or additionally, the image may comprise one or more of the following: a still image, an animated image, a video image, or a holographic image, or combinations thereof. Alternatively or additionally, the audio accompaniment may comprise one or more of the following: spoken word, sound effect, or music, or combinations thereof.

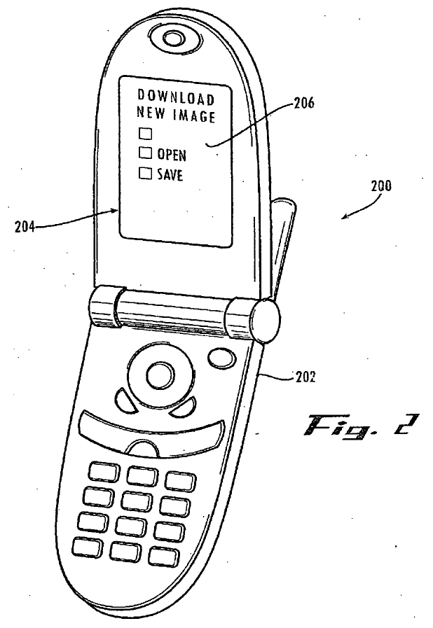

Referring to FIG. 2, an illustration of portable electronic device 200 according to one or more embodiments is shown, although the claimed subject matter is not limited in scope in this respect. Portable electronic device 200 may include more and/or fewer components than those shown in FIG. 2. However, generally conventional components may not be shown, for example a battery, a processor, and so on. Illustrated in FIG. 2, portable electronic device 200 may include a housing 202 that may be capable of being personally portable, such as, for example, being carried and/or worn by a user, although the claimed subject matter is not limited in scope in this respect. As used herein, the term “portable” comprises, but is not limited to, being capable of being carried on and/or by a person. Housing 202 may comprise any number of devices, such as, for example, a handheld computer, a Personal Digital Assistant, a tablet computer, a pocket personal computer, a mobile phone, a smartphone, a portable media player, or the like, or combinations thereof. However, this is merely an example, and the scope of the claimed subject matter is not limited in this respect. Portable electronic device 200 may include a display 204. As shown, the portable electronic device 200 may display an option 206 to download an image to a user via display 204. Option 206 may take the form of a menu or the like and may be installed as part of the portable electronic device 200 either in the factory or in the field, such as, in the software operating system, although the claimed subject matter is not limited in this respect. Alternatively or additionally, portable electronic device 200 may be pre-loaded with an inventory of one or more pre-set images for display. However, this is merely an example, and the scope of the claimed subject matter is not limited in this respect.

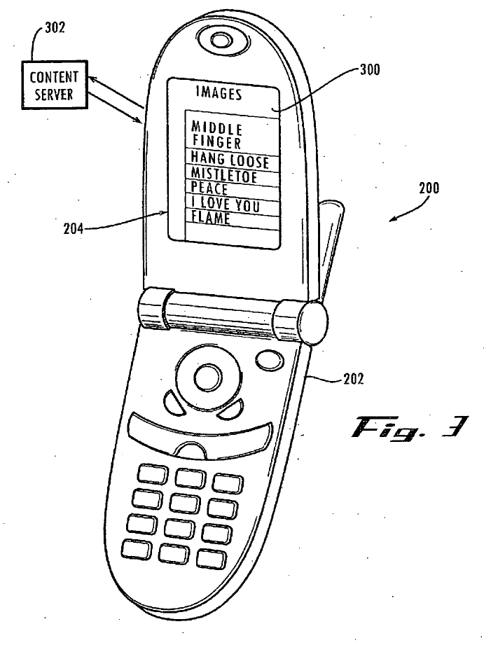

Referring to FIG. 3, an illustration of portable electronic device 200 according to one or more embodiments is shown, although the claimed subject matter is not limited in scope in this respect. Portable electronic device 200 may be pre-loaded with and/or download a compatible application to an operating system of the portable electronic device 200. With the compatible application the portable electronic device 200 may deploy a menu for services so that then when an item is selected it is programmed properly using the application programming interface (API) so that the operating system may be compatible with the Dynamically-Linked Library (DDL) of the portable electronic device 200 to transmit a request to the server 302 to deliver the image via over-the-air programming (OTA). Alternatively or additionally, portable electronic device 200 may be pre-loaded with an inventory of one or more pre-set images for display.

Portable electronic device 200 may display an inventory of one or more images available for download 300 once the user has selected the option to download an image via display 204. The inventory of one or more images available for download 300 may be in the form of a text list, or the like, although the scope of the claimed subject matter is not limited in this respect. Portable electronic device 200 may transmit a request for one or more images available for downloading from a server 302. Portable electronic device 200 may purchase the requested one or more images by performing one or more communications back and forth with the server 302 to validate billing. Portable electronic device 200 may download the one or more purchased images. Alternatively or additionally, portable electronic device 200 may display a confirmation message that the purchase was approved. Alternatively or additionally, portable electronic device 200 may display a message that the purchase was not approved.

Additionally or alternatively, portable electronic device 200 may display an inventory of images available for display 300 from which a user may select for display. For example, portable electronic device 200 may display an inventory of images available for display 300 from which a user may select for display, where the images were either downloaded and/or pre-loaded in the portable electronic device 200. The inventory of images available for display 300 may be in the form of a text list, or the like, although the scope of the claimed subject matter is not limited in this respect.

Additionally or alternatively, portable electronic device 200 may be actualized by having software downloaded or otherwise installed on portable electronic device 200 that facilitates the selection, billing, downloading and deployment of the culturally significant images so that the images may be displayed on one or more displays 204 of one or more portable electronic devices 200. Unless pre-loaded onto portable electronic device 200; software, content and billing sequences may be handled by a single or multiple sets of servers 302. Additionally or alternatively, communications from/to portable electronic device 200 and/or server 302 may contain encryption and/or decryption for the security of users and their data.

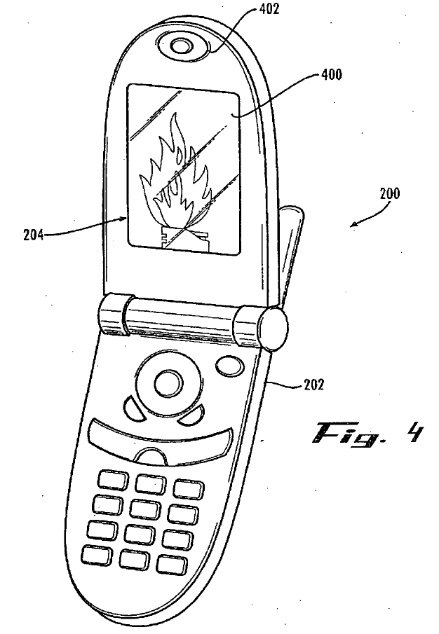

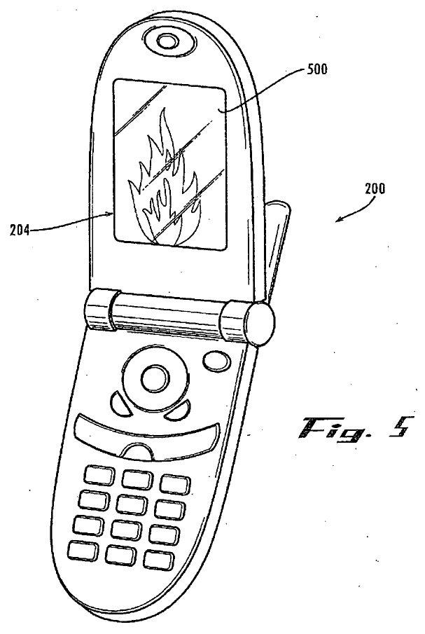

Referring to FIG. 4, an illustration of portable electronic device 200 according to one or more embodiments is shown, although the claimed subject matter is not limited in scope in this respect. Portable electronic device 200 may display selected images 400 via display 204. Alternatively or additionally, portable electronic device 200 may play an audio accompaniment via speaker 402 in conjunction with the displaying via display 204. The image 400 displayed by portable electronic device 200 may comprise a culturally significant object conveying a message through non-verbal communication. For example, the culturally significant object may comprise a lighter and flame, or the like. Similarly, in FIG. 5, portable electronic device 200 may display selected image 500 via display 204, where the image 500 may comprise a culturally significant object conveying a message through non-verbal communication such as a flame, or the like. However, this is merely an example, and the scope of the claimed subject matter is not limited in this respect.

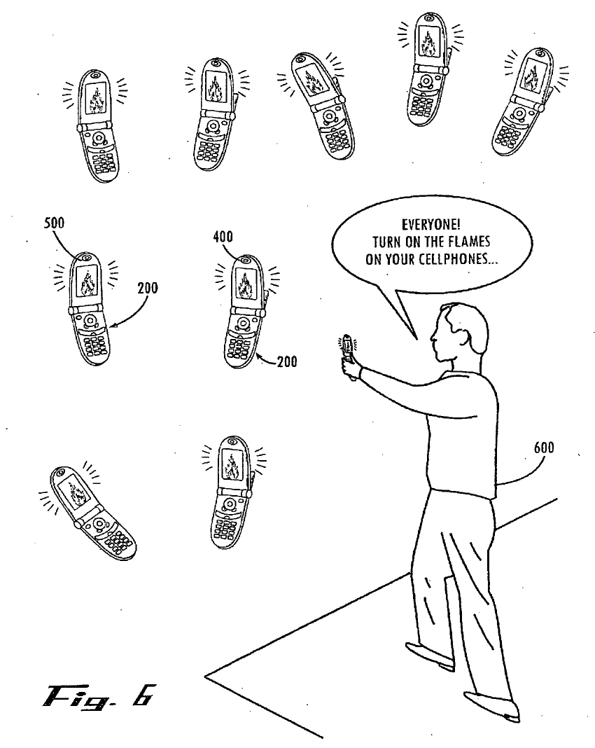

Referring to FIG. 6, an illustration of portable electronic device 200 in use according to one or more embodiments is shown, although the claimed subject matter is not limited in scope in this respect. In FIG. 6, a performer 600 may instruct the audience to turn on their lighter and flame displays 400 and/or flame displays 500, and the users in the audience respond with the proper deployment of images. Additionally or alternatively, performer 600 may instruct the users in the audience with portable electronic devices 200 how to turn portable electronic devices 200 to maximize the simulation of the established cultural tradition and users in the audience may respond with the proper positioning and deployment of images (such as image 400 and/or image 500) on their portable electronic devices 200. Thus, two or more users may present a culturally significant object (such as image 400 and/or image 500) displayed on two or more portable electronic devices 200 to one or more individuals to convey a message through non-verbal communication.

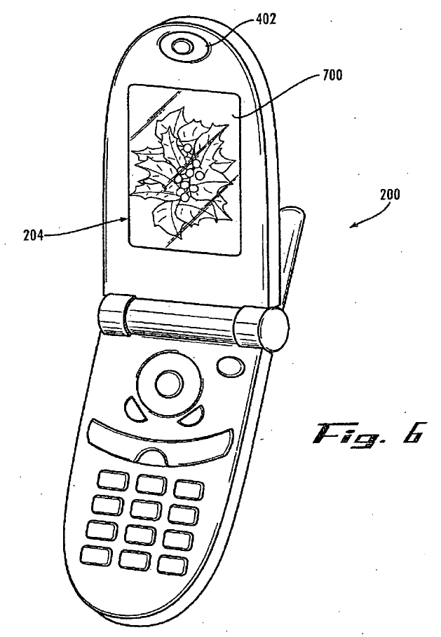

Referring to FIG. 7, an illustration of portable electronic device 200 according to one or more embodiments is shown, although the claimed subject matter is not limited in scope in this respect. Portable electronic device 200 may display selected images 700 via display 204. Alternatively or additionally, portable electronic device 200 may play an audio accompaniment via speaker 402 in conjunction with the displaying via display 204. The image 700 displayed by portable electronic device 200 may comprise a culturally significant object conveying a message through non-verbal communication. For example, the culturally significant object may comprise mistletoe, or the like. However, this is merely an example, and the scope of the claimed subject matter is not limited in this respect.

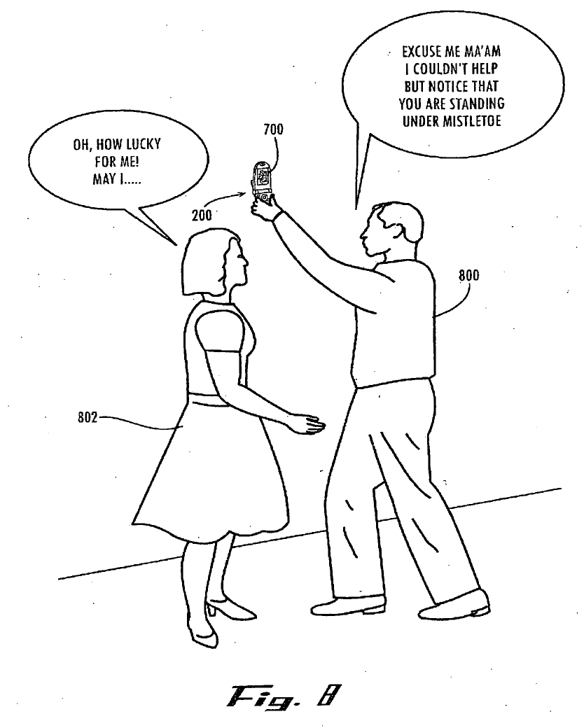

Referring to FIG. 8, an illustration of portable electronic device 200 in use according to one or more embodiments is shown, although the claimed subject matter is not limited in scope in this respect. In FIG. 7, a device user 800 may employ the popular cultural tradition of kissing under the mistletoe by deploying the mistletoe image 700 on portable electronic device 200. For example, user 800 may position portable electronic device 200 over the head of a person 802 he would like to kiss and uttering the familiar words “I couldn't help but notice you were under the mistletoe and then gain a response from the person 802, either a kiss or some form of rejection, although the scope of the claimed subject matter is not limited in this respect. Thus, one or more users may present a culturally significant object (such as image 700) displayed on one or more portable electronic devices 200 to one or more individuals 802 to convey a message through non-verbal communication.

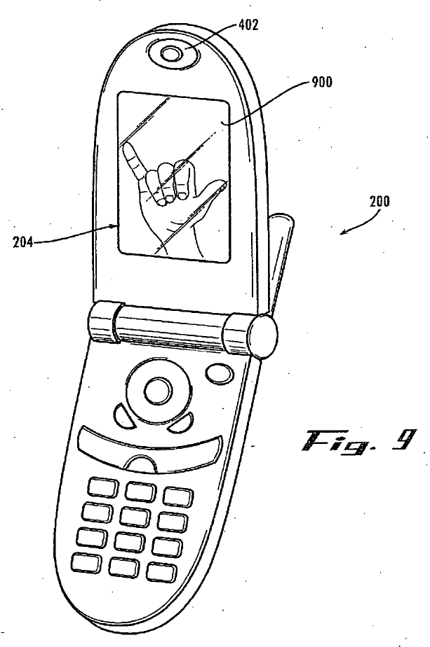

Referring to FIG. 9, an illustration of portable electronic device 200 according to one or more embodiments is shown, although the claimed subject matter is not limited in scope in this respect. Portable electronic device 200 may display selected images 900 via display 204. Alternatively or additionally, portable electronic device 200 may play an audio accompaniment via speaker 402 in conjunction with the displaying via display 204. The image 900 displayed by portable electronic device 200 may comprise a hand gesture conveying a message through non-verbal communication. For example, the hand gesture may comprise a hang-loose gesture, or the like. However, this is merely an example, and the scope of the claimed subject matter is not limited in this respect.

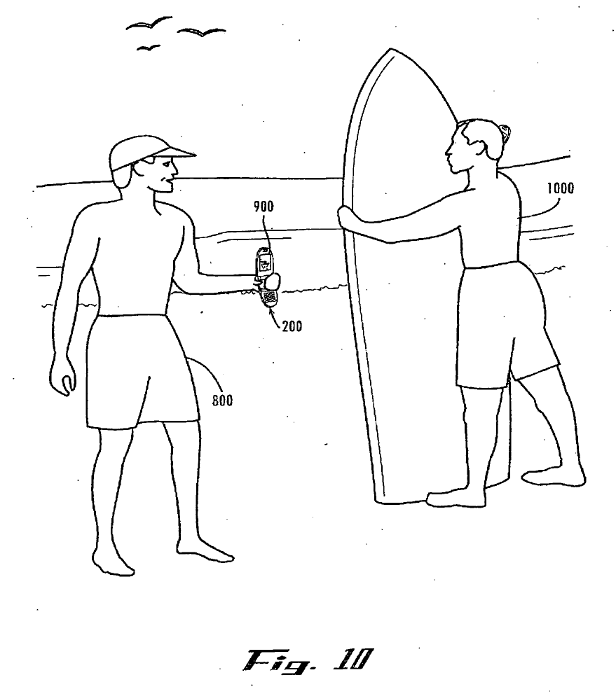

Referring to FIG. 10, an illustration of portable electronic device 200 in use according to one or more embodiments is shown, although the claimed subject matter is not limited in scope in this respect. In FIG. 10, a device user 800 may employ hang-loose gesture 900 via portable electronic device 200 to conveying a message through non-verbal communication to a friend 1000. The hang-loose gesture is a popular symbol in the state of Hawaii as well as throughout skate and surf culture. For example, user 800 may display the hang-loose gesture 900 via portable electronic device 200 to friend 1000 so that friend 1000 knows that user 800 is leaving without disturbing friend 1000 who may be the phone, although the scope of the claimed subject matter is not limited in this respect. Thus, one or more users may present a hand gesture (such as image 900) displayed on one or more portable electronic devices 200 to one or more individuals 1000 to convey a message through non-verbal communication.

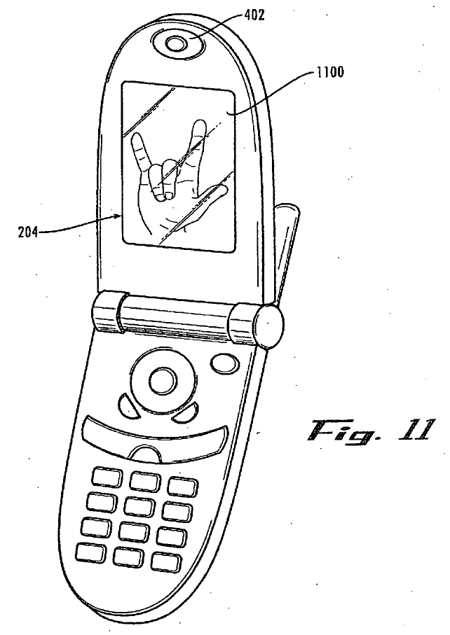

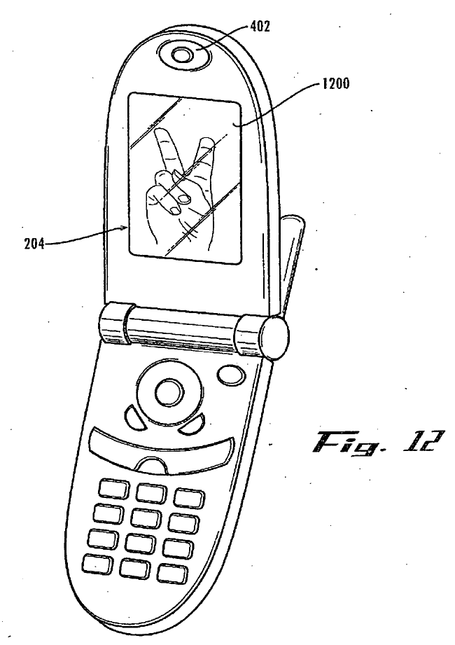

Referring to FIG. 11, an illustration of portable electronic device 200 according to one or more embodiments is shown, although the claimed subject matter is not limited in scope in this respect. Portable electronic device 200 may display selected images 1100 via display 204. Alternatively or additionally, portable electronic device 200 may play an audio accompaniment via speaker 402 in conjunction with the displaying via display 204. The image 1100 displayed by portable electronic device 200 may comprise a hand gesture conveying a message through non-verbal communication. For example, the hand gesture may comprise an I love you gesture, or the like. Similarly, as shown in FIG. 12, image 1200 displayed by portable electronic device 200 may comprise a hand gesture conveying a message through non-verbal communication, where the hand gesture may comprises a peace gesture, or the like. However, this is merely an example, and the scope of the claimed subject matter is not limited in this respect.

In use, a user 800 may present an image (such as image 400, 500, 700, 900, 1100, and/or 1200) displayed on the portable electronic device 200 to one or more individuals to convey a message through non-verbal communication. Alternatively or additionally, two or more users 800 may present the image displayed on two or more portable electronic devices 200 to one or more individuals to convey a message through non-verbal communication. Accordingly, a user 800 may display an image, such as a graphical image, video or animation sequence which may be coupled with an audio accompaniment to enact a culturally familiar sequence, communication or tradition that usually is not initiated or aided via the use of a portable electronic device 200. For example, a mobile phone user 800 may choose a select image (such as image 400, 500, 700, 900, 1100, and/or 1200) possibly with audio signal to download to his mobile phone. During the holiday season, the user 800 may choose to download an audiovisual representation of mistletoe 700. Once downloaded to the phone 200 the user may then select the audio, video or audiovisual image(s) of the mistletoe 700 for display and attempt to simulate the cultural ceremony of kissing someone under the mistletoe by positioning the image(s) 700 on the mobile phone 200 strategically over the head of the individual the user seeks to kiss. Where a user 800 desires a specific image, the portable electronic device 200 may be pre-loaded at the factory and/or downloaded by the user 800 with an inventory of one or more images. The inventory of one or more images may then be accessed through the portable electronic device 200, such as through a menu displayed upon the portable electronic device 200, for example. The displayed image (such as image 400, 500, 700, 900, 1100, and/or 1200) may be used by a user 800 to tie specifically into a culturally accepted sequence, communication or tradition. The communication may be something that is meant for communication by a single user 800 and/or communication by a group of two or more users 800, and/or as part of a group or collaborative activity.

Referring to FIG. 13, a block diagram illustrates a computing platform 1300 of a portable electronic device 200 according to one or more embodiments, although the claimed subject matter is not limited in scope in this respect. Computing platform 1300 may include more and/or fewer components than those shown in FIG. 13. However, generally conventional components may not be shown, for example, a battery, a bus, and so on.

Computing platform 1300, as shown in FIG. 13 may be utilized to tangibly embody a computer program and/or graphical user interface by providing hardware components on which the computer program and/or graphical user interface may be executed. Such a computer program and/or machine readable instructions may be tangibly stored on a computer and/or machine readable storage medium such as a compact disk (CD), digital versatile disk (DVD), flash memory device, hard disk drive (HDD), and so on. As shown in FIG. 13, computing platform 1300 may be controlled by processor 1304, including one or more auxiliary processors (not shown). Processor 1304 may comprise a central processing unit such as a microprocessor or microcontroller for executing programs, performing data manipulations, and controlling the tasks of computing platform 1300. Auxiliary processors may manage input/output, perform floating point mathematical operations, manage digital signals, perform fast execution of signal processing algorithms, operate as a back-end processor and/or a slave-type processor subordinate to processor 1304, operate as an additional microprocessor and/or controller for dual and/or multiple processor systems, and/or operate as a coprocessor and/or additional processor. Such auxiliary processors may be discrete processors and/or may be arranged in the same package as processor 1304, for example, in a multicore and/or multithreaded processor; however, the scope of the claimed subject matter is not limited in these respects.

Communication with processor 1304 may be implemented via a bus (not shown) for transferring information among the components of computing platform 1300. A bus may include a data channel for facilitating information transfer between storage and other peripheral components of computing platform 1300. A bus further may provide a set of signals utilized for communication with processor 1304, including, for example, a data bus, an address bus, and/or a control bus. A bus may comprise any bus architecture according to promulgated standards, for example, industry standard architecture (ISA), extended industry standard architecture (EISA), micro channel architecture (MCA), Video Electronics Standards Association local bus (VLB), peripheral component interconnect (PCI) local bus, PCI express (PCIe), hyper transport (HT), standards promulgated by the Institute of Electrical and Electronics Engineers (IEEE) including EEE 488 general-purpose interface bus (GPIB), IEEE 696/S-100, and so on, although the scope of the claimed subject matter is not limited in this respect.

Other components of computing platform 1300 may include, for example, memory 1306, including one or more auxiliary memories (not shown). Memory 1306 may provide storage of instructions and data for programs to be executed by processor 1304, such as a program 1308, for example. Memory 1306 may be, for example, semiconductor-based memory such as dynamic random access memory (DRAM) and/or static random access memory (SRAM), and/or the like. Other semi-conductor-based memory types may include, for example, synchronous dynamic random access memory (SDRAM), Rambus dynamic random access memory (RDRAM), ferroelectric random access memory (FRAM), and so on. Alternatively or additionally, memory 1306 may be, for example, magnetic-based memory, such as a magnetic disc memory, a magnetic tape memory, and/or the like; an optical-based memory, such as a compact disc read write memory, and/or the like; a magneto-optical-based memory, such as a memory formed of ferromagnetic material read by a laser, and/or the like; a phase-change-based memory such as phase change memory (PRAM), and/or the like; a holographic-based memory such as rewritable holographic storage utilizing the photorefractive effect in crystals, and/or the like; and/or a molecular-based memory such as polymer-based memories, and/or the like. Auxiliary memories may be utilized to store instructions and/or data that are to be loaded into memory 1306 before execution. Auxiliary memories may include semiconductor based memory such as read-only memory (ROM), programmable read-only memory (PROM), erasable programmable read-only memory (EPROM), electrically erasable read-only memory (EEPROM), and/or flash memory, and/or any block oriented memory similar to EEPROM. Auxiliary memories also may include any type of non-semiconductor-based memories, including, but not limited to, magnetic tape, drum, floppy disk, hard disk, optical, laser disk, compact disc read-only memory (CD-ROM), write once compact disc (CD-R), rewritable compact disc (CD-RW), digital versatile disc read-only memory (DVD-ROM), write once DVD (DVD-R), rewritable digital versatile disc (DVD-RAM), and so on. Other varieties of memory devices are contemplated as well.

Computing platform 1300 further may include a display 1310. Display 1310 may comprise a video display adapter having components, including, for example, video memory, a buffer, and/or a graphics engine. Such video memory may be, for example, video random access memory (VRAM), synchronous graphics random access memory (SGRAM), windows random access memory (WRAM), and/or the like. Display 1310 may comprise a cathode ray-tube (CRT) type display such as a monitor and/or television, and/or may comprise an alternative type of display technology such as a projection type CRT type display, a liquid-crystal display (LCD) projector type display, an LCD type display, a light-emitting diode (LED) type display, a gas and/or plasma type display, an electroluminescent type display, a vacuum fluorescent type display, a cathodoluminescent and/or field emission type display, a plasma addressed liquid crystal (PALC) type display, a high gain emissive display (HGED) type display, and so forth.

Computing platform 1300 further may include one or more I/O devices 1312. I/O device 1312 may comprise one or more I/O devices 1312 such as a keyboard, mouse, trackball, touchpad, joystick, track stick, infrared transducers, printer, modem, RF modem, bar code reader, charge-coupled device (CCD) reader, scanner, compact disc (CD), compact disc read-only memory (CD-ROM), digital versatile disc (DVD), video capture device, TV tuner card, touch screen, stylus, electroacoustic transducer, microphone, speaker, audio amplifier, and/or the like.

Computing platform 1300 further may include an external interface 1314. External interface 1314 may comprise one or more controllers and/or adapters to prove interface functions between multiple I/O devices 1312. For example, external interface 1314 may comprise a serial port, parallel port, universal serial bus (USB) port, and IEEE 1394 serial bus port, infrared port, network adapter, printer adapter, radio-frequency (RF) communications adapter, universal asynchronous receiver-transmitter (UART) port, and/or the like, to interface between corresponding I/O devices 1312.

In the preceding description, various aspects of the claimed subject matter have been described. For purposes of explanation, specific numbers, systems and/or configurations were set forth to provide a thorough understanding of the claimed subject matter. However, it should be apparent to one skilled in the art having the benefit of this disclosure that the claimed subject matter may be practiced without the specific details. In other instances, well-known features were omitted and/or simplified so as not to obscure the claimed subject matter. While certain features have been illustrated and/or described herein, many modifications, substitutions, changes and/or equivalents will now occur to those skilled in the art. It is, therefore, to be understood that the appended claims are intended to cover all such modifications and/or changes as fall within the true spirit of the claimed subject matter.

What is claimed is:

1. A method, comprising:
displaying an image on a portable electronic device; and
wherein the image comprises a culturally significant object conveying a message through non-verbal communication.

2. The method of claim 1, wherein the culturally significant object comprises mistletoe.

3. The method of claim 1, wherein the culturally significant object comprises a lighter and flame.

4. The method of claim 1, wherein the culturally significant object comprises a flame.

5. The method of claim 1, wherein the image comprises one or more of the following: a still image, an animated image, a video image, or a holographic image, or combinations thereof.

6. The method of claim 1, further comprising displaying an inventory of available images prior to said displaying.

7. The method of claim 1, further comprising presenting the displayed image to one or more individuals by a user the portable electronic devices.

8. The method of claim 1, further comprising presenting the displayed image to one or more individuals by two or more users of two or more of the portable electronic devices.

9. The method of claim 1, further comprising playing an audio accompaniment in conjunction with said displaying, wherein the audio accompaniment comprises one or more of the following: spoken word, sound effect, or music, or combinations thereof.

10. The method of claim 1, further comprising:
displaying on the portable electronic device an inventory of one or more images available for download;
requesting at least one of said one or more images available for download; and
downloading the requested images.

11. The method of claim 1, further comprising:
displaying on the portable electronic device an inventory of one or more images available for download;
requesting at least one of said one or more images available for download;
purchasing the requested images; and
downloading the purchased images.

12. The method of claim 1, wherein the portable electronic device comprises one or more of the following: a handheld computer, a Personal Digital Assistant, a tablet computer, a pocket personal computer, a mobile phone, a smartphone, or a portable media player, or combinations thereof.

13. An article of manufacture, comprising: a storage medium having stored thereon instructions, that, if executed, result in:
displaying an image on a portable electronic device; and
wherein the image comprises a culturally significant object conveying a message through non-verbal communication.

14. The article of claim 13, wherein the culturally significant object is mistletoe, a lighter and flame, or a flame.

15. The article of claim 13, wherein the image comprises one or more of the following: a still image, an animated image, a video image, or a holographic image, or combinations thereof.

16. The article of claim 13, wherein the instructions, if executed, further result in displaying an inventory of available images prior to said displaying.

17. The article of claim 13, wherein the instructions, if executed, further result in playing an audio accompaniment in conjunction with said displaying, wherein the audio accompaniment comprises one or more of the following: spoken word, sound effect, or music, or combinations thereof.

18. The article of claim 13, wherein the instructions, if executed, further result in:
displaying on the portable electronic device an inventory of one or more images available for download;
requesting at least one of said one or more images available for download; and
downloading the requested images.

19. The article of claim 13, wherein the instructions, if executed, further result in:
displaying on the portable electronic device an inventory of one or more images available for download;
requesting at least one of said one or more images available for download;
purchasing the selected images; and
downloading the purchased images.

20. An apparatus, comprising:
means for displaying on the portable electronic device an inventory of one or more images available for display, wherein the image comprises a culturally significant object conveying a message through non-verbal communication; and
means for displaying the image on the portable electronic device.

21. The apparatus of claim 20, wherein the culturally significant object is mistletoe, a lighter and flame, or a flame.

22. The apparatus of claim 20, wherein the image comprises one or more of the following: a still image, an animated image, a video image, or a holographic image, or combinations thereof.

23. The apparatus of claim 20, further comprising means for playing an audio accompaniment in conjunction with said displaying, wherein the audio accompaniment comprises one or more of the following: spoken word, sound effect, or music, or combinations thereof.

24. The apparatus of claim 20, further comprising:
means for displaying on the portable electronic device an inventory of one or more images available for download;
means for requesting at least one of said one or more images available for download; and
means for downloading the requested images.

25. The apparatus of claim 20, further comprising:
means for displaying on the portable electronic device an inventory of one or more images available for download;
means for requesting at least one of said one or more images available for download;
means for purchasing the requested images; and
means for downloading the purchased images.

26. The apparatus of claim 20, wherein the portable electronic device comprises one or more of the following: a handheld computer, a Personal Digital Assistant, a tablet computer, a pocket personal computer, a mobile phone, a smartphone, or a portable media player, or combinations thereof.

27. A method, comprising:
displaying an image on a portable electronic device; and
wherein the image comprises a hand gesture conveying a message through non-verbal communication.

28. The method of claim 27, wherein the hand gesture comprises an I love you gesture.

29. The method of claim 27, wherein the hand gesture comprises a hang-loose gesture.

30. The method of claim 27, wherein the hand gesture comprises a peace gesture.

31. The method of claim 27, wherein the hand gesture comprises an extended middle finger gesture.

32. The method of claim 27, wherein the image comprises one or more of the following: a still image, an animated image, a video image, or a holographic image, or combinations thereof.

33. The method of claim 27, further comprising displaying an inventory of available images prior to said displaying.

34. The method of claim 27, further comprising presenting the displayed image to one or more individuals by a user the portable electronic devices.

35. The method of claim 27, further comprising presenting the displayed image to one or more individuals by two or more users of two or more of the portable electronic devices.

36. The method of claim 27, further comprising playing an audio accompaniment in conjunction with said displaying, wherein the audio accompaniment comprises one or more of the following: spoken word, sound effect, or music, or combinations thereof.

37. The method of claim 27, further comprising:
displaying on the portable electronic device an inventory of one or more images available for download;
requesting at least one of said one or more images available for download; and
downloading the requested images.

38. The method of claim 27, further comprising:
displaying on the portable electronic device an inventory of one or more images available for download;
requesting at least one of said one or more images available for download;
purchasing the requested images; and
downloading the purchased images.

39. The method of claim 27, wherein the portable electronic device comprises one or more of the following: a handheld computer, a Personal Digital Assistant, a tablet computer, a pocket personal computer, a mobile phone, a smartphone, or a portable media player, or combinations thereof.

40. An article of manufacture, comprising: a storage medium having stored thereon instructions, that, if executed, result in:
displaying an image on a portable electronic device; and
wherein the image comprises a hand gesture conveying a message through non-verbal communication.

41. The article of claim 40, wherein the hand gesture comprises one or more of the following: an I love you gesture, a hang-loose gesture, an extended middle finger gesture, or a peace gesture, or combinations thereof.

42. The article of claim 40, wherein the image comprises one or more of the following: a still image, an animated image, a video image, or a holographic image, or combinations thereof.

43. The article of claim 40, wherein the instructions, if executed, further result in displaying an inventory of available images prior to said displaying.

44. The article of claim 40, wherein the instructions, if executed, further result in playing an audio accompaniment in conjunction with said displaying, wherein the audio accompaniment comprises one or more of the following: spoken word, sound effect, or music, or combinations thereof.

45. The article of claim 40, wherein the instructions, if executed, further result in:
displaying on the portable electronic device an inventory of one or more images available for download;
requesting at least one of said one or more images available for download; and
downloading the requested images.

46. The article of claim 40, wherein the instructions, if executed, further result in:
displaying on the portable electronic device an inventory of one or more images available for download;
requesting at least one of said one or more images available for download;
purchasing the selected images; and
downloading the purchased images.

47. An apparatus, comprising:
means for displaying on the portable electronic device an inventory of one or more images available for display, wherein the image comprises a hand gesture conveying a message through non-verbal communication; and
means for displaying the image on the portable electronic device.

48. The apparatus of claim 47, wherein the hand gesture comprises one or more of the following: an I love you gesture, a hang-loose gesture, an extended middle finger gesture, or a peace gesture, or combinations thereof.

49. The apparatus of claim 47, wherein the image comprises one or more of the following: a still image, an animated image, a video image, or a holographic image, or combinations thereof.

50. The apparatus of claim 47, further comprising means for playing an audio accompaniment in conjunction with said displaying, wherein the audio accompaniment comprises one or more of the following: spoken word, sound effect, or music, or combinations thereof.

51. The apparatus of claim 47, further comprising:
means for displaying on the portable electronic device an inventory of one or more images available for download;
means for requesting at least one of said one or more images available for download; and
means for downloading the requested images.

52. The apparatus of claim 47, further comprising:
means for displaying on the portable electronic device an inventory of one or more images available for download;
means for requesting at least one of said one or more images available for download;
means for purchasing the requested images, and means for downloading the purchased images.

53. The apparatus of claim 47, wherein the portable electronic device comprises one or more of the following: a handheld computer, a Personal Digital Assistant, a tablet computer, a pocket personal computer, a mobile phone, a smartphone, or a portable media player, or combinations thereof.
